(19) United States
(12) Patent Application Publication
(10) Pub. No.: US 2006/0026795 A1
(43) Pub. Date: Feb. 9, 2006

(54) Hinge for cases, trunks and the like

(75) Inventor: Massimo Tonelli, Casalecchio Di Reno (IT)

Correspondence Address: MODIANO & ASSOCIATI, Via Meravigli, 16, MILAN, 20123, IT

(73) Assignee: GT LINE S.R.L.

(21) Appl. No.: 11/181,760

(22) Filed: Jul. 15, 2005

(30) Foreign Application Priority Data
Jul. 22, 2004 (IT) BO2004A000454

(51) Int. Cl. E05D 7/00

(52) U.S. Cl. 16/221

(57) ABSTRACT

A hinge for cases, trunks and the like, comprising a first member that is rigidly coupled to the first half-shell of the case, a second member that is rigidly coupled to the second half-shell of the case and is articulated to the first member, and selective coupling elements, which are suitable to keep the first member and the second member coupled to each other in at least one angular configuration for locking the second half-shell with respect to the first half-shell, and to allow the quick disconnection of the second member from the first member in at least one angular configuration for free separation of the second half-shell with respect to the first half-shell.

### BACKGROUND OF THE INVENTION

In some particular professional fields, cases or trunks are used extensively to accommodate and carry, among other items, scientific instruments or devices of any kind so that they can be used actively on site.

For this purpose, these instruments or devices are accommodated in a fixed position within one of the half-shells of the case or trunk, while the other half-shell acts substantially as a cover for closure and protection.

In some particular applications, and for the most disparate reasons, it is necessary to be able to separate rapidly the half-shell that acts as a cover from the half-shell the acts as a receptacle for the instruments, so as to allow the operator to work in maximum comfort and without hindrances. In known types of case and trunk, this result is achieved with constructive solutions that are rather complicated and onerous from the point of view of production costs and further require a certain number of work steps (for example, the disassembly of connecting elements and their subsequent reassembly).

### SUMMARY OF THE INVENTION

The aim of the present invention is to obviate the cited drawbacks, by providing a hinge for cases, trunks and the like that allows the user to separate rapidly the half-shells from each other with a small number of simple manual operations.

Within this aim, an object of the present invention is to provide a structure that is simple, relatively easy to provide in practice, safe in use, effective in operation, and has a relatively low cost.

This aim and this and other objects that will become better apparent hereinafter are achieved by the present hinge for cases, trunks and the like, characterized in that it comprises a first member that is rigidly coupled to the first half-shell of the case, a second member that is rigidly coupled to the second half-shell of the case and is articulated to said first member, and selective coupling means, which are suitable to keep said first member and said second member coupled to each other in at least one angular configuration for locking said second half-shell with respect to said first half-shell, and are further suitable to allow the quick disconnection of said second member from said first member in at least one angular configuration for free separation of said second half-shell with respect to said first half-shell.

### BRIEF DESCRIPTION OF THE DRAWINGS

Further characteristics and advantages will become better apparent from the following detailed description of a preferred but not exclusive embodiment of a hinge for cases, trunks and the like according to the invention, illustrated by way of non-limiting example in the accompanying drawings, wherein:

FIG. 1 is a perspective view of a case with hinges according to the invention, with the first half-shell and the second half-shell in an angular configuration for free separation;

FIG. 2 is a side elevation view of said case, with the first half-shell and the second half-shell in the same angular configuration for free separation;

FIG. 3 is a detail side elevation view of the hinge according to the invention, in an angular configuration for locking the second half-shell with respect to the first half-shell;

FIG. 4 is a detail side elevation view of the hinge in another angular configuration for locking the second half-shell with respect to the first half-shell;

FIG. 5 is a detail side elevation view of the hinge in a configuration for freely separating the second half-shell from the first half-shell;

FIGS. 6, 7 and 8 are respective detail perspective views of the hinge according to the invention, in a sequence for coupling the second member to the first member.

In the embodiment that follows, individual characteristics, given in relation to this specific example, may actually be interchanged with other different characteristics that exist in other embodiments.

Moreover, it is noted that anything found to be already known during the patenting process is understood not to be claimed and to be the subject of a disclaimer.

### DESCRIPTION OF THE PREFERRED EMBODIMENTS

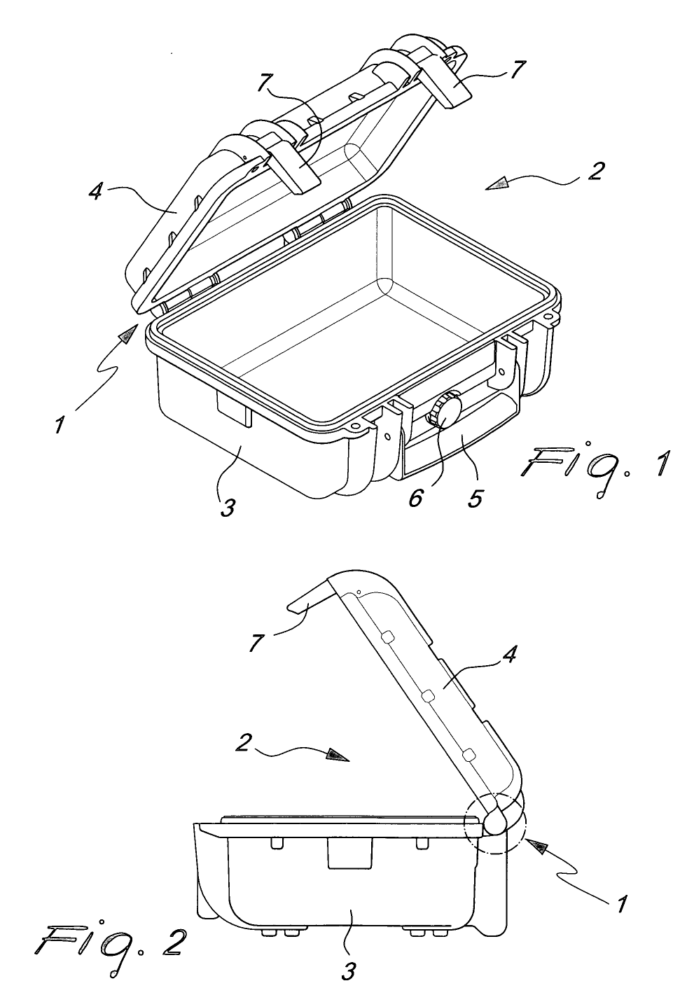

With reference to FIGS. 1 and 2, the reference numeral 1 generally designates a hinge for cases, trunks and the like according to the invention. In the figures cited above, a pair of hinges 1 is provided on a case, generally designated by the reference numeral 2, which comprises a first half-shell 3 and a second half-shell 4, which are mutually articulated by means of said hinges, a handle 5, and locks 6 and 7. However, it is evident that the hinges 1 can also be provided on trunks or the like or on any other container substantially constituted by two half-shells.

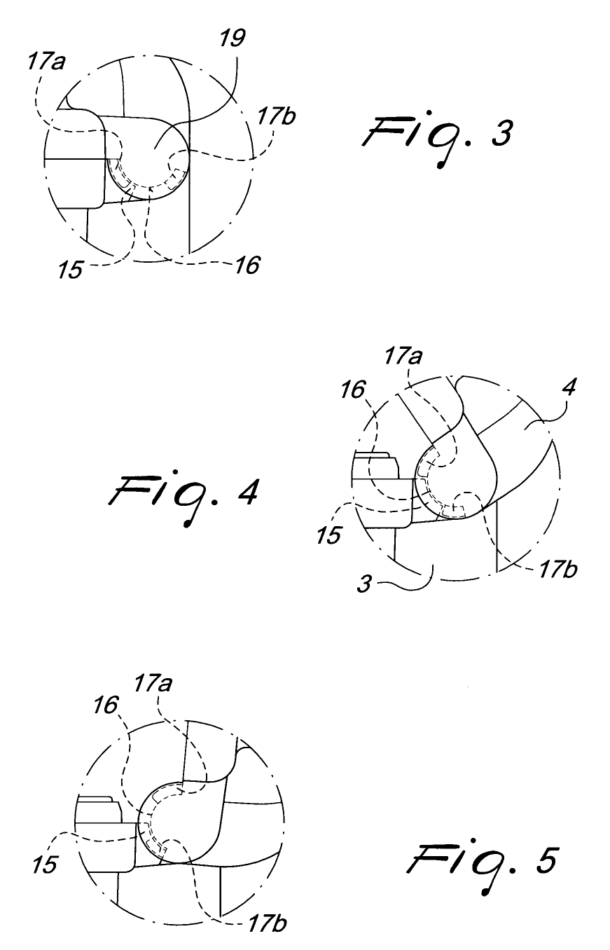

The hinge according to the invention comprises a first member 8, which is rigidly coupled to the first half-shell 3 of the case 2, and a second member 9, which is rigidly coupled to the second half-shell 4 and is articulated to the first member 8. The hinge further advantageously comprises means for selective coupling, which are generally designated by the reference numeral 10 and are suitable to keep the first member 8 and the second member 9 coupled to each other in at least one angular configuration for locking the second half-shell 4 with respect to the first half-shell 3 (FIGS. 3 and 5). The selective coupling means 10 are further suitable to allow the quick and easy disconnection of the second member 9 from the first member 8 in at least one angular configuration for free separation of the second half-shell 4 from the first half-shell 3 (FIG. 4).

In greater detail, the first member 8 and the second member 9 are constituted by substantially cylindrical elongated tabs, which are rigidly coupled respectively to the first edge 11 and to the second edge 12 of the first half-shell 3 and of the second half-shell 4; the first member 8 and the second member 9 have axes of symmetry that are substantially parallel respectively to the first edge 11 and to the second edge 12. The first member 8 (or, as an alternative, the second member 9), is provided with a pivot-like articulation extension 13, which is suitable to engage detachably in a respective hole 14 provided in the second member 9 (FIG. 6).

Conveniently, the means 10 for selectively coupling the second member 9 to the first member 8 preferably have two configurations for locking the second half-shell 4 with respect to the first half-shell 3, i.e., respectively, so that the first and second half-shells are completely closed (FIG. 3) and completely open (FIG. 5). In these configurations, it is not possible to separate the first half-shell 3 from the second half-shell 4, and said half-shells are therefore mutually locked.

The selective coupling means 10 further have advantageously a configuration for free separation of the second half-shell 4 from the first half-shell 3; this configuration is provided when said first half-shell 3 and said second half-shell 4 are in an intermediate angular position (FIG. 4), for example one in which the first and second half-shells form an angle of approximately 45° with respect to each other. In this configuration, therefore, it is possible to separate manually the second half-shell 4 from the first half-shell 3 very quickly and easily in order to be able to use without hindrance the instruments or devices accommodated in the first half-shell 3.

Conveniently, according to the invention the selective coupling means 10 comprise at least one tooth 15, which is rigidly coupled to the first edge 11 proximate to the first member 8, and at least one longitudinal groove 16, which is provided along the second member 9 so as to form two parallel ridges 17a and 17b. The groove 16 runs advantageously from one end of the second member 9 to an annular slot 18, which is formed by a substantially disk-like expansion 19 provided at the opposite end and has an angular extension that is preferably substantially equal to a straight angle.

The tooth 15 is suitable to engage, in each of the two locking configurations, the annular slot 18 so as to abut against one or the other of the ridges 17a and 17b (FIGS. 3 and 5), thus preventing the separation of the second member 9 from the first member 8. The tooth 15 is further suitable, in the free separation configuration of FIG. 4, to slide, by lateral traction of the second half-shell 4, along the groove 16 until it slides out of it, so as to allow the disconnection of the second member 9 from the first member 8 and therefore of the second half-shell 4 from the first half-shell 3.

The longitudinal groove 16 conveniently has a transverse cross-section that is substantially shaped like an annular segment, while the tooth 15 has accordingly a transverse cross-section that is substantially complementary to the cross-section of the groove 16: a suitable play is provided between the tooth 15 and the groove 16 so as to allow the easy sliding of the former along the latter during the separation of the second half-shell 4 from the first half-shell 3.

The method of use of the case with the hinge according to the invention is fully intuitive in view of what has been described. In addition to using the case according to normal conditions of use, it is possible to separate the first half-shell 3 from the second half-shell 4 very quickly and simply, by arranging the second half-shell 4 manually, with respect to the first half-shell 3, in an intermediate angular position that corresponds to the free separation configuration. In this configuration, the tooth 15 faces the groove 16 and can slide along it by pulling the second half-shell 4 laterally with respect to the first half-shell 3.

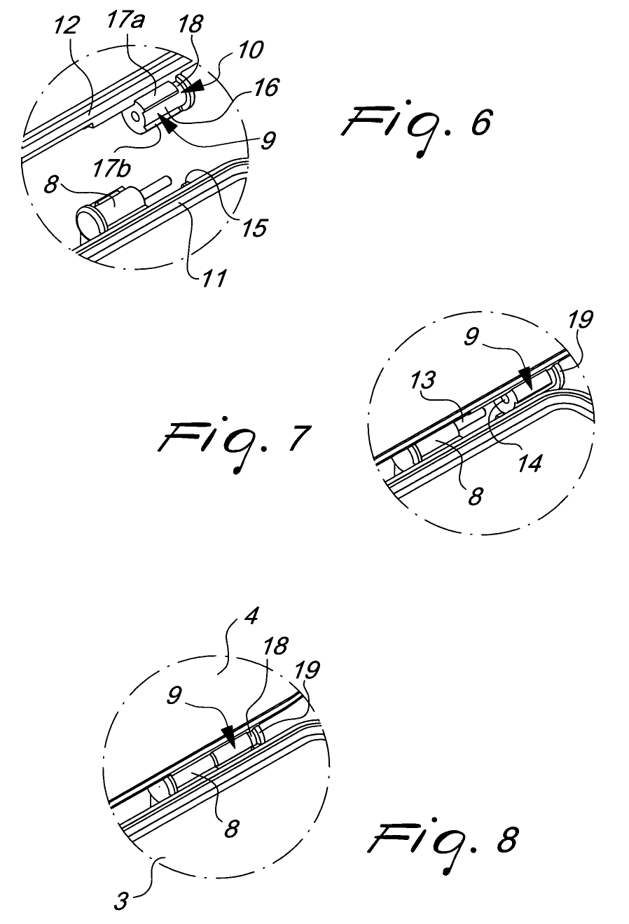

In a fully equivalent manner, the first half-shell 4 can be reassembled to the first half-shell 3, as shown in sequence in FIGS. 6, 7 and 8, by taking care to slide the tooth 15 along the slot 16 while the pivot-like extension 13 is inserted in the hole 14.

It has thus been found that the invention achieves the intended aim and object.

The hinge according to the invention, preferably manufactured at low cost in a single mold in the first and second half-shells, is particularly advantageous in all situations requiring extremely practical and quick use of the instruments contained in the case, with particular reference to the operation for removing the second half-shell (protective cover) and reassembling it.

The invention thus conceived is susceptible of numerous modifications and variations, all of which are within the scope of the appended claims.

All the details may further be replaced with other technically equivalent ones.

The embodiment of the present invention shall be carried out in the most scrupulous compliance with the statutory and regulatory provisions related to the products of the invention or correlated thereto and following any required authorization of the corresponding competent authorities, with particular reference to regulations related to safety, environmental pollution and health.

In practice, the materials used, as well as the shapes and dimensions, may be any according to requirements without thereby abandoning the protective scope of the appended claims.

The disclosures in Italian Patent Application No. BO2004A000454 from which this application claims priority are incorporated herein by reference.

What is claimed is:

1. A hinge for cases, comprising: a first and a second half-shells; a first member rigidly coupled to the first half-shell; a second member rigidly coupled to the second half-shell and articulated to said first member; and selective coupling means, for coupling the first and second members to each other so as to keep said first member and said second member coupled to each other in at least one angular configuration for locking said second half-shell with respect to said first half-shell, and so as to allow a quick disconnection of said second member from said first member in at least one angular configuration for free separation of said second half-shell with respect to said first half-shell.

2. The hinge of claim 1, wherein said first member and said second member are constituted by tabs that have a substantially elongated shape, said tabs being rigidly coupled respectively to a first edge of said first half-shell and to a second edge of said second half-shell and being parallel to said first and second edges, said first member being provided with a pivot-like articulation extension, adapted to engage detachably within a hole provided in said second member.

3. The hinge of claim 2, wherein said selective coupling means are provided so as to keep said first and second members coupled together in two said configurations for locking said second half-shell with respect to said first half-shell, in which said first half-shell and said second half-shell are, respectively, completely closed and completely open, and in a configuration for the free separation of said second half-shell from said first half-shell with said first and second half-shells in an intermediate angular position.

4. The hinge of claim 3, wherein said selective coupling means comprise: at least one tooth, which is rigidly coupled to said first edge proximate to said first member; and at least one longitudinal groove, which is provided along said second member and forms two parallel ridges, said groove running from one end to another, opposite end of said second member, an expansion provided at said opposite end of the second member; an annular slot formed by said expansion, said groove extending to said annular slot, said tooth being suitable, in said locking configurations, to engage in said slot, abutting respectively against one or the other of said ridges, said tooth being further slidable along said groove until disengagement therefrom in said free separation configuration, so as to allow the disconnection of said second half-shell from said first half-shell.

5. The hinge of claim 4, wherein said groove has a transverse cross-section that is shaped substantially as an annular sector, said tooth having a transverse cross-section that is substantially complementary to the cross-section of said groove, and wherein a play is provided between said tooth and said groove so as to allow sliding of said tooth along said groove for insertion and extraction.

6. The hinge of claim 4, wherein said slot has an angular extension that is substantially equal to a straight angle.
